(19) United States
(12) Patent Application Publication
(10) Pub. No.: US 2026/0089383 A1
(43) Pub. Date: Mar. 26, 2026

(54) SYSTEM AND METHOD FOR CAMERALESS PHOTOGRAPHY

(71) Applicant: National Taipei University of Technology, Taipei (TW)

(72) Inventors: Huei-Yung Lin, Taipei (TW); Ming-Yiao Chen, Taipei (TW)

(21) Appl. No.: 18/942,870

(22) Filed: Nov. 11, 2024

(30) Foreign Application Priority Data
Sep. 25, 2024 (TW) 113136419

(51) Int. Cl. H04N 23/60; G06F 3/14; H04N 9/73

(52) U.S. Cl. CPC H04N 23/60; G06F 3/14; H04N 9/73

(57) ABSTRACT

The present invention provides a system and a method for cameraless photography, which includes an environment acquisition module and a calculation module. The environment acquisition module includes a smart device loaded with software, a global positioning system, an application programming interface, and an inertial measurement unit, in which the global positioning system and the inertial measurement unit generate environmental information, and the application programming interface generates weather information and time information. The calculation module includes a computing unit and an image database, in which after the computing unit receives the environmental information, the weather information and the time information, the computing unit filters out at least one image in the image database that best matches the environmental information, the weather information and the time information, and the smart device then displays the image. The environment acquisition module communicates with the calculation module.

### CROSS-REFERENCE TO RELATED APPLICATIONS

This application claims priority to Taiwan Application Serial Number 113136419, filed Sep. 25, 2024, which is herein incorporated by reference in its entirety.

### BACKGROUND

### Technical Field

The present invention relates to a system and a method for photography, in particular to a system and a method for cameraless photography that can generate an image based on a current location, time, orientation and weather condition without a camera.

### Related Art

Nowadays, there are quite a variety of devices that can be used for photography, and cameras and mobile phones are constantly being introduced. Recording life at any time has become a habit of many people. In addition, many people seek convenience and do not carry mobile phones or cameras during short-term leisure activities, but instead wear smart wearable devices. Without a mobile phone or camera, they cannot record their life at any time, which is really a pity.

Currently, there are technologies that use location information to retrieve pictures or other landscape information related to the location, but most of them are used for map navigation or other commercial purposes. However, images generated by this method cannot fully match the current situation, and are not refined enough, and are less likely to meet the user's expectations for image content.

Therefore, in order to reduce the occurrence of such situations, today's imaging systems can capture a large number of images, and then use artificial intelligence to edit or modify the images according to environmental conditions, such as light and shadow, background, object material or texture, etc. Although the images generated by this method are more detailed, it can only edit the generated images and cannot display an image that fits the current scene.

In addition, in a current imaging device, a photo can also be received through an optical sensing unit, and calculated and then stored in an optical data unit, and then the photo is edited with optical parameters that matches the current environment through artificial intelligence, and then make modifications based on user preferences to finally generate an image. Although this method can make the image closer to reality, it can only adjust the optical values and cannot change an actual content of the image.

In summary, the technology of image generation through artificial intelligence is becoming increasingly developed, but there are still many areas for improvement. For example, the image does not fully fit the current situation, or the generated image does not meet the user's preferences and image's refinement degree. Therefore, in view of the above problems, how to provide a system and a method for cameraless photography that can satisfy the user's preferences is still an important issue to be solved.

### SUMMARY

Therefore, the object of the present invention is to provide a system and a method for cameraless photography that can improve image realism.

In view of the above objectives, the present invention provides a system for cameraless photography, which includes: an environment acquisition module, which includes a smart device loaded with software, a global positioning system (GPS), an application programming interface (API) and an inertial measurement unit (IMU), in which the global positioning system and the inertial measurement unit generate environmental information, and the application programming interface generates weather information and time information; and a calculation module, which includes a computing unit and an image database, in which after the computing unit receives the environmental information, the weather information and the time information, the computing unit filters out at least one image in the image database that best matches the environmental information, the weather information and the time information, and the smart device then displays the image. The environment acquisition module communicates with the calculation module.

In an embodiment of the system for cameraless photography of the present invention, the inertial measurement unit includes a gyroscope.

In an embodiment of the system for cameraless photography of the present invention, the environmental information includes three-axis coordinates, an elevation angle and a facing orientation.

In an embodiment of the system for cameraless photography of the present invention, the software controls a shooting parameter.

In an embodiment of the system for cameraless photography of the present invention, the shooting parameter include aperture, white balance, focal length or exposure time.

The present invention further provides a method for cameraless photography, which includes following steps: first, providing an environment acquisition module, which includes a smart device loaded with software, a global positioning system, an application programming interface and an inertial measurement unit; providing a calculation module, which includes a computing unit and an image database; opening the software, starting a photography interface and adjusting a shooting parameter, then photographing; generating environmental information through the global positioning system and the inertial measurement unit; generating weather information and time information through the application programming interface; after the computing unit receiving and combining the environmental information, the weather information and the time information, filtering out at least one image in the image database that best matches the combined environmental information, weather information and time information; displaying the at least one image that best matches through the smart device.

In an embodiment of the method for cameraless photography of the present invention, the inertial measurement unit includes a gyroscope.

In an embodiment of the method for cameraless photography of the present invention, the environmental information includes three-axis coordinates, an elevation angle and a facing orientation.

In an embodiment of the method for cameraless photography of the present invention, a method for establishing the image database further includes following steps: respectively taking a plurality of images at different times, different elevation angles, different facing orientations and different seasons at a plurality of locations in advance, and obtaining a download link for the images; storing the images, the download link, the shooting parameter, the environmental information, the weather information and the time information in the image database.

In an embodiment of the method for cameraless photography of the present invention, the shooting parameter include aperture, white balance, focal length or exposure time.

### BRIEF DESCRIPTION OF THE DRAWINGS

FIG. 1 is a schematic diagram of a system for cameraless photography of the present invention.

FIG. 2 is a flow chart of a method for cameraless photography of the present invention.

FIG. 3 is a flow chart of a method for establishing an image database of the present invention.

### DETAILED DESCRIPTION OF THE EMBODIMENTS

In order to facilitate the Examiner to understand structural features, content and advantages of the present invention and effects it can achieve, the present invention is described in detail below with accompanying drawings and in the form of embodiments. The drawings used herein are only for illustration and assist the description. The content mentioned is not intended to limit the present invention. Therefore, the claimed scope of the present invention should not be limited to the actual implementation. The exemplary embodiments are described in detail below with reference to the drawings.

In the present invention, unless otherwise explicitly stipulated and limited, terms such as “disposed”, “fixed” and “connected” should be understood in a broad sense. For example, it can be a fixed connection or a detachable connection or integrated; it can be mechanically connected, directly connected, or indirectly connected through an intermediate medium. For those skilled in the art, specific meanings of the above terms in the present invention can be understood according to specific circumstances.

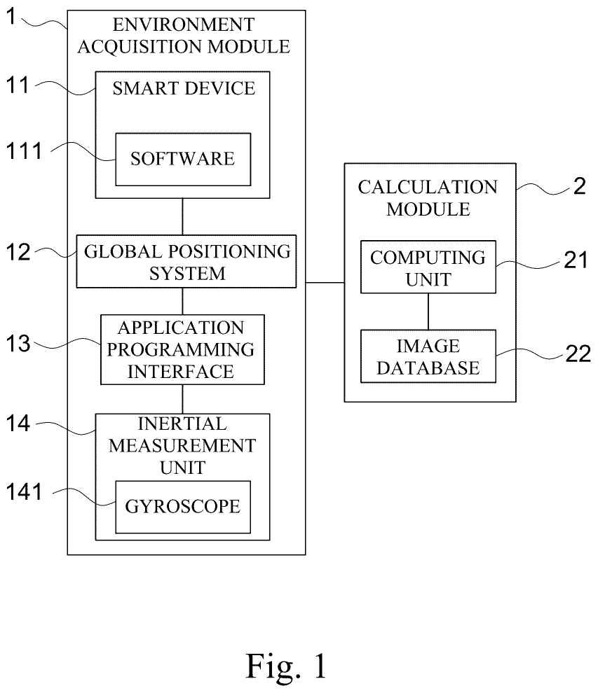

First, please refer to FIG. 1. The present invention provides a system for cameraless photography, which includes an environment capture module 1 and a calculation module 2, and the environment capture module 1 communicates with the calculation module 2. The environment acquisition module 1 further includes a smart device 11 loaded with software 111, a global positioning system (GPS) 12, an application programming interface (API) 13 and an inertial measurement unit 14. The calculation module 2 includes a computing unit 21 and an image database 22.

Among them, the global positioning system 12 uses low-frequency signals, which can maintain considerable signal penetration even if the weather is bad. It also has a global coverage rate of up to 98%, which can accurately locate the user's location, and the inertial measurement unit 14 is used to measure the three-axis attitude angle and acceleration of the object, so the environmental information of the user's location can be generated through the global positioning system 12 and the inertial measurement unit 14. On the other hand, the application programming interface 13 generates weather information and time information at the user's location through Internet searches, such as meteorological observation data of the automatic weather station from the government data open platform. Next, the computing unit 21 in the calculation module 2 receives the environmental information, the weather information and the time information, and after combining them, searches and filters out at least one image in the image database 22 that best matches the environmental information, the weather information and the time information of the user's location, and the smart device 11 then display the filtered image.

The software 111 contained in the smart device 11 of the present invention is the software 111 developed by the inventor of the present invention. In one embodiment of the present invention, a name of the software 111 used is photo information uploader, which can assemble the photo collection system to organize all the information needed for image filtering, such as longitude, latitude, yaw, roll, pitch, weather, white balance, etc., and images and image information can also be uploaded to the image database 22 for storage.

In another embodiment of the system for cameraless photography of the present invention, a name of the software 111 used is cameraless photography, which is the software 111 that can organize a photo retrieval system, which gathers a variety of environmental information, such as longitude and latitude, yaw, roll, pitch, weather or white balance, and cooperates with a shooting parameter set by the user, such as exposure time or white balance, and then retrieves an image with similar status in the image database 22.

In one embodiment of the system for cameraless photography of the present invention, a platform of the image database 22 is established through Firebase. Firebase is a back-end real-time service platform for mobile devices that assists users to quickly create a backend service in the cloud. In the present invention, the image database 22 is established through two systems, Firebase Firestore and Firebase Storage in Firebase. In this image database 22, the user should first store multiple captured images in Firebase Storage and obtain a download link at the same time. Next, exchangeable image file format (EXIF) information of the images and the download link of the images are stored in Firebase Storage. The image file format is a file format specially set for photos taken by digital cameras, which can record attribute information and shooting situation of the image, including time, exposure, photo length and width, white balance, longitude and latitude, weather status, weather station name or three-axis information, etc.

Please refer to Table (1) and Table (1) continuation below, which are schematic tables for the establishment and collection of the image database 22.

TABLE 1
Firebase Firestore

| | | Exposure | White | Station | |
|---|---|---|---|---|---|
| | Time | Time | Balance | Name | Weather |
| Data 1 | 2024 Mar. 18 | 0.0199 | 0 | Songshan | cloudy |
| | 13:04:21 | | | | |
| Data 2 | 2024 Mar. 18 | 0.0666 | 0 | Songshan | partly cloudy |
| | 19:26:24 | | | | |
| Data 3 | 2024 Apr. 7 | 0.0333 | 0 | Xinyi | cloudy |
| | 14:54:37 | | | | |

| | Roll | Yaw | Pitch | Download Link |
|---|---|---|---|---|
| Data 1 | −0.192 | 56.230 | −35.23 | https: //Firebase . . . |
| Data 2 | 9.5320 | −149.8 | −51.33 | https: //Firebase . . . |
| Data 3 | −85.75 | 109.00 | −0.303 | https: //Firebase . . . |

Image retrieval is performed through comparison of shooting conditions such as time, exposure, photo length and width, white balance, longitude and latitude, weather status, weather station name or three-axis information as described in Table (1) and Table (1) continued.

In one embodiment of the system for cameraless photography of the present invention, when shooting, the application programming interface 13 and the inertial measurement unit 14 in the environment capture module 1 generates the weather information, the time information and the environment information. The weather information is obtained through the government's open platform. By obtaining the current weather condition and then retrieving based on the weather condition, it can avoid excessive difference between the final image obtained and the scene at the time of shooting due to different weather conditions, resulting in the loss of the authenticity of the image. The time information is obtained through the application programming interface 13. By obtaining the current time and then retrieving it based on the shooting season or time period, it avoids different scenery due to different shooting seasons. On the other hand, different shooting time periods also cause the difference in brightness and darkness of the scenery, making the final image less authentic. The inertial measurement unit 14 generates environmental information, and calculates three-axis coordinates, elevation angle and facing orientation of the current shooting through the gyroscope 141 provided therein, and obtains a current shooting angle, and then retrieves based on photos with similar shooting angles to avoid the difference between the scenery in the image and the current shooting situation due to different shooting angles. When performing image retrieval, the calculation module 2 filters out an image in the image database 22 that is most similar to the weather station, weather condition, facing orientation, elevation angle, time and exposure status of the shooting moment to ensure that the image conforms to the conditions and characteristics of the shooting moment and increase the authenticity of the image.

In an embodiment of the system for cameraless photography of the present invention, the software 111 contained in the smart device 11 can control shooting parameters, where the shooting parameters include aperture, white balance, focal length or exposure time. The aperture is a component on a camera used to control a size of the lens aperture to control depth of field and lens image quality, and focal length is a distance from the center of the lens to an image sensor to control a size of the field of view. The setting of white balance affects a tone of the image. When the calculation module 2 performs image retrieving, white balance also becomes one of the image retrieval conditions to avoid losing the authenticity of the image due to the difference in tone. On the other hand, the setting of the exposure time affects the brightness of the image and the degree of dynamic blur. Therefore, when the calculation module 2 performs image retrieving, the retrieval of the exposure time also becomes one of the image retrieval conditions.

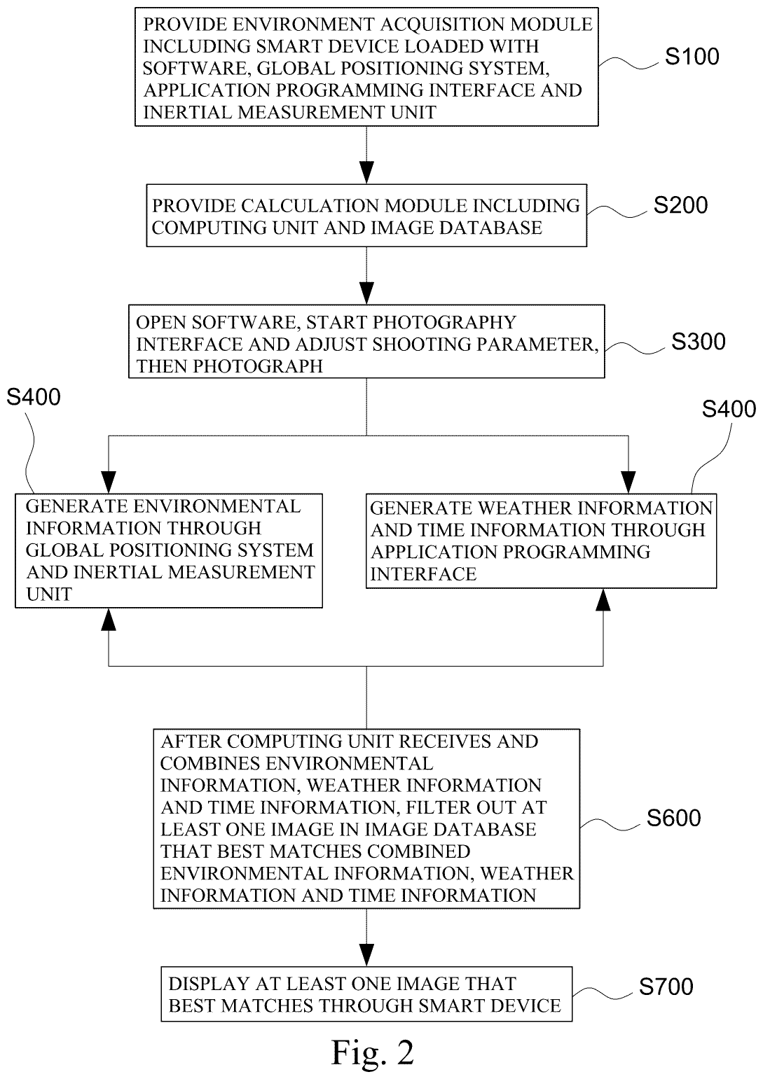

Please refer to FIG. 2, which is a flow chart of a method for cameraless photography of the present invention, including following steps:
Step S100: an environment acquisition module is provided, which includes a smart device loaded with software, a global positioning system, an application programming interface, and an inertial measurement unit.
Step S200: a calculation module is provided, which includes a computing unit and an image database.
Step S300: after the software is opened, and a photography interface is started and shooting parameters are adjusted, shooting is performed. The software used in the present invention is the software developed by the inventor of the present invention, which can assemble the software of the photo collection system to organize all the information needed for image retrieving, such as longitude and latitude, yaw, roll, pitch, weather, white balance, etc., and can also upload images and image information to the image database for storage.
Step S400: The global positioning system and the inertial measurement unit generate environmental information. The global positioning system uses low-frequency signals, which have strong signal penetration and high global coverage, and can accurately locate the user's location. The inertial measurement unit is used to measure the three-axis attitude angle and acceleration of the object. Therefore, the global positioning system and the inertial measurement unit can generate the environmental information about the user's location.
Step S500: The application programming interface generates weather information and time information. The application programming interface generates the weather information and the time information at the user's location through Internet searches, such as meteorological observation data of the automatic weather station from the government data open platform.
Step S600: After the computing unit receives and combines the environmental information, the weather information and the time information, it retrieves at least one image in the image database that best matches the combined environmental information, the weather information and the time information.
Step S700: The smart device displays the at least one of the best matching image.

In step S100, the inertial measurement unit includes a gyroscope. Three-axis coordinates, elevation angle and facing orientation of the current shooting are calculated through the gyroscope provided therein, and a current shooting angle is obtained, and retrieval is then performed based on photos with similar shooting angles to avoid the difference between the scenery in the image and the current shooting situation due to different shooting angles.

In step S400, the environmental information includes the three-axis coordinates, the elevation angle and the facing orientation.

In step S600, by obtaining the weather information, the time information and the environmental information, the computing unit performs retrieval based on the weather information, the time information and the environmental information to avoid excessive difference between the final image obtained and the scene at the time of shooting due to different scenery, resulting in the loss of the authenticity of the image. When performing image retrieval, the calculation module filters out an image in the image database that is most similar to the weather station, weather condition, facing orientation, elevation angle, time and exposure status of the shooting moment to ensure that the image conforms to the conditions and characteristics of the shooting moment and increase the authenticity of the image.

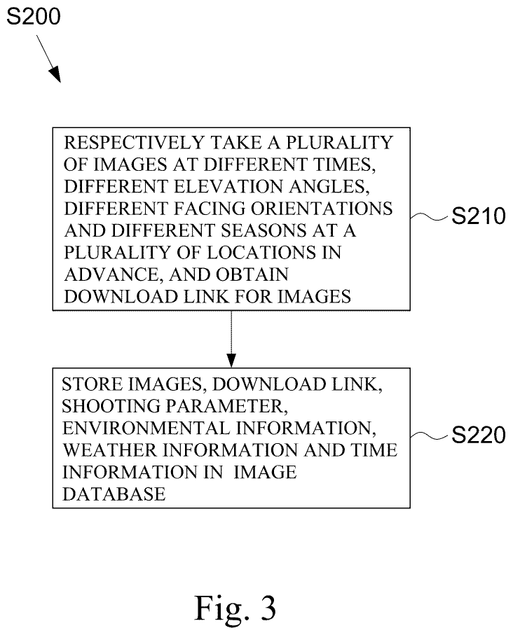

Please refer to FIG. 3, which is a flow chart of a method for establishing an image database of the present invention, which includes following steps:
Step S210: a plurality of images are captured in advance and a download link for the images is obtained.
Step S220: the images, the download link of the images, shooting parameters, environmental information, weather information and time information of the images are stored in the image database.

In step S210, in order to establish an image database, the user should take images at different times, different elevation angles, different facing orientations and different seasons at various locations. In one embodiment of the present invention, an image database is established through Firebase. In the present invention, an image database is established through two systems, Firebase Firestore and Firebase Storage in Firebase. The user should first store multiple captured images in Firebase Storage and obtain a download link at the same time. Next, the exchangeable image file format information of the images and the download link of the images are stored in Firebase Storage, and attribute information and shooting situation of the image, including time, exposure, photo length and width, white balance, longitude and latitude, weather status, weather station name or three-axis information, etc. are recorded.

In step S220, the shooting parameters include aperture, white balance, focal length or exposure time. The aperture is used to control depth of field and lens image quality, and focal length is used to control a size of the field of view. The setting of white balance affects a tone of the image. When the calculation module performs image retrieving, white balance also becomes one of the image retrieval conditions to avoid losing the authenticity of the image due to the difference in tone. On the other hand, the setting of the exposure time affects the brightness of the image and the degree of dynamic blur. Therefore, when the calculation module performs image retrieving, the retrieval of the exposure time also becomes one of the image retrieval conditions.

In view of this, the system and the method for cameraless photography provided by the present invention solve the problems that the images generated by artificial intelligence today cannot fully conform to the current situation, and the generated image does not meet the user's preferences, and the image precision is insufficient.

In summary, each embodiment is only used to illustrate the content of the present invention and does not limit the implementation scope of the present invention. Therefore, any person familiar with the relevant knowledge in the field of the present invention can easily think of modifications or changes. All can be covered by the patent scope of the present invention.

What is claimed is:

1. A system for cameraless photography, comprising:
an environment acquisition module, which includes a smart device loaded with software, a global positioning system (GPS), an application programming interface (API) and an inertial measurement unit (IMU), wherein the global positioning system and the inertial measurement unit generate environmental information, and the application programming interface generates weather information and time information; and
a calculation module, which includes a computing unit and an image database, wherein after the computing unit receives the environmental information, the weather information and the time information, the computing unit filters out at least one image in the image database that best matches the environmental information, the weather information and the time information, and the smart device then displays the image;
wherein the environment acquisition module communicates with the calculation module.

2. The system for cameraless photography of claim 1, wherein the inertial measurement unit includes a gyroscope.

3. The system for cameraless photography of claim 1, wherein the environmental information includes three-axis coordinates, an elevation angle and a facing orientation.

4. The system for cameraless photography of claim 1, wherein the software controls a shooting parameter.

5. The system for cameraless photography of claim 4, wherein the shooting parameter include aperture, white balance, focal length or exposure time.

6. A method for cameraless photography, comprising following steps:
(a) providing an environment acquisition module, which includes a smart device loaded with software, a global positioning system, an application programming interface and an inertial measurement unit;
(b) providing a calculation module, which includes a computing unit and an image database;
(c) opening the software, starting a photography interface and adjusting a shooting parameter, then photographing;
(d) generating environmental information through the global positioning system and the inertial measurement unit;
(e) generating weather information and time information through the application programming interface;
(f) after the computing unit receiving and combining the environmental information, the weather information and the time information, filtering out at least one image in the image database that best matches the combined environmental information, weather information and time information;
(g) displaying the at least one image that best matches through the smart device.

7. The method for cameraless photography of claim 6, wherein the inertial measurement unit includes a gyroscope.

8. The method for cameraless photography of claim 6, wherein the environmental information includes three-axis coordinates, an elevation angle and a facing orientation.

9. The method for cameraless photography of claim 6, wherein a method for establishing the image database further comprises following steps:
(b1) respectively taking a plurality of images at different times, different elevation angles, different facing orientations and different seasons at a plurality of locations in advance, and obtaining a download link for the images;
(b2) storing the images, the download link, the shooting parameter, the environmental information, the weather information and the time information in the image database.

10. The method for cameraless photography of claim 6, wherein the shooting parameter include aperture, white balance, focal length or exposure time.
